(19) United States
(12) Patent Application Publication
(10) Pub. No.: US 2026/0362410 A1
(43) Pub. Date: Nov. 12, 2026

(54) TECHNOLOGIES FOR BANDWIDTH PART SWITCHING

(71) Applicant: Apple Inc., Cupertino, CA (US)

(72) Inventors: Seyed Ali Akbar Fakoorian, San Diego, CA (US); Hongbo Yan, Vista, CA (US); Parisa Babaheidarian, Saratoga, CA (US); Wanshi Chen, San Diego, CA (US); Wei Zeng, Saratoga, CA (US)

(73) Assignee: Apple Inc., Cupertino, CA (US)

(21) Appl. No.: 19/642,529

(22) Filed: Apr. 8, 2026

Related U.S. Application Data
(60) Provisional application No. 63/803,446, filed on May 9, 2025.

(51) Int. Cl. H04W 72/0457; H04B 7/06; H04L 1/1812; H04L 5/00; H04W 56/00; H04W 72/12; H04W 72/231

(52) U.S. Cl. CPC H04W 72/0457; H04B 7/06968; H04L 1/1812; H04L 5/0044; H04L 5/0051; H04W 56/0015; H04W 72/12; H04W 72/231

(57) ABSTRACT

The present application relates to devices and components including apparatus, systems, and methods for bandwidth part (BWP) configuration and BWP switching operation.

### CROSS-REFERENCE TO RELATED APPLICATION

This application claims priority to U.S. Provisional Patent Application No. 63/803,446, entitled “TECHNOLOGIES FOR BANDWIDTH PART SWITCHING,” filed on May 9, 2025, which is herein incorporated by reference in its entirety for all purposes.

### TECHNICAL FIELD

This application relates generally to communication networks and, in particular, to configuration of bandwidth part (BWP) and BWP switching operation.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a time-frequency diagram in accordance with some embodiments.

FIG. 3 illustrates an association in accordance with some embodiments.

FIG. 4 illustrates a scheduling in accordance with some embodiments.

FIG. 5 illustrates a timing diagram in accordance with some embodiments.

FIG. 6 illustrates an operation flow/algorithmic structure in accordance with some embodiments.

FIG. 7 illustrates another operation flow/algorithmic structure in accordance with some embodiments.

FIG. 8 illustrates another operation flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

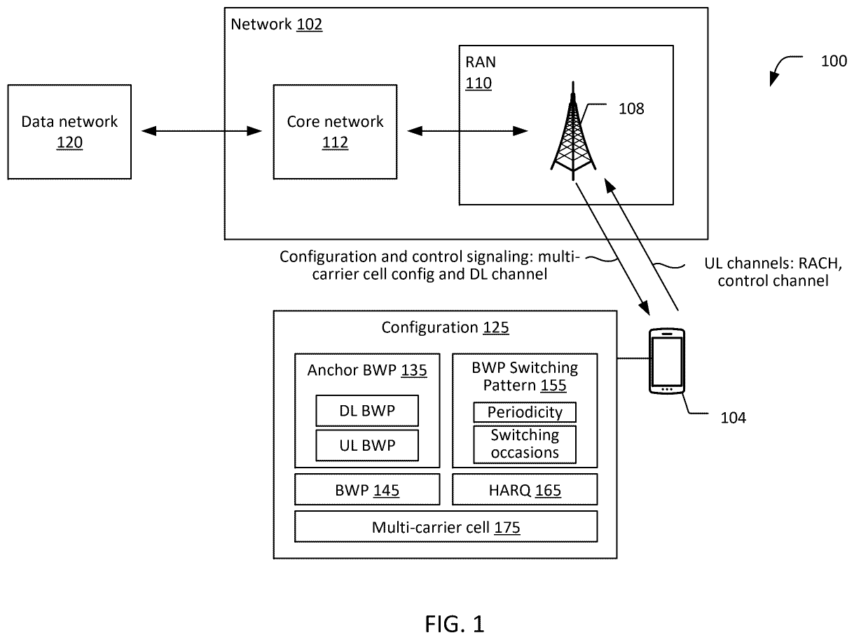

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

Operations described herein as associated with devices of the network environment 100 (for example, the UE 104 and the base station 108) may be fully, substantially, or partially performed by processor circuitry of the device.

The network environment 100 may further include a core network 112. For example, the core network 112 may comprise a 5th Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions. The core network 112, RAN 110, and base station 108 may collectively be referred to as network 102.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Network 102 may generate and transmit configuration 125 to UE 104. This configuration 125 may include parameters to configure uplink (UL) channels, downlink (DL) channels, bandwidth parts (BWPs) (e.g., BWP 135 or BWP 145), or multi-carrier cells (e.g., multi-carrier cell 175). For example, UL channels may include a physical uplink control channel (PUCCH) and a random access channel (RACH), while DL channels may include a physical downlink control channel (PDCCH) and reference signals, such as a tracking reference signal (TRS). The configuration information 125 may enable UE 104 to communicate with base station 108, supporting resource allocation, synchronization, and bandwidth utilization.

Network 102 may configure the UE 104 with a multi-carrier cell. A multi-carrier cell may include multiple carrier components that may be contiguous or non-contiguous in frequency and may be associated with one or more serving cells. The network 102 may send the configuration to the UE 104 to set up a multi-carrier cell, e.g., multi-carrier cell 175 configuration, enabling the UE 104 to perform uplink or downlink transmissions across multiple component carriers. The multi-carrier cell configuration 175 may include parameters for scheduling transmissions, managing BWPs, and sharing hybrid automatic repeat request (HARQ) processes across multiple component carriers. HARQ processes may facilitate reliable data transmission by allowing retransmissions of failed transport blocks across different component carriers. The multi-carrier cell configuration 175 may improve bandwidth utilization and enhance data throughput for the UE 104.

Network 102 may configure BWPs for the UE 104 (e.g., anchor BWP 135 or BWP 145). A BWP may represent a subset of system bandwidth allocated for uplink or downlink transmissions between the UE 104 and the base station 108. The network 102 may dynamically define BWPs for the UE 104 based on traffic demand, application requirements, or network conditions. The UE 104 may perform BWP switching to adapt its transmission and reception configurations to changing network requirements. BWP switching operations may involve transitioning between different BWPs while maintaining communication continuity and managing resource utilization. For example, BWP switching may occur during handoffs between serving cells or to improve resource allocation in multi-carrier cells.

Bandwidth part management in mobile communication systems may face challenges that complicate switching operations, reduce efficiency, and degrade network performance. For example, existing bandwidth part switching mechanisms may introduce ambiguity or delays during switching operations, particularly in scenarios involving multi-carrier cells or overlapping resource allocations. The absence of predictable switching patterns may require dynamic signaling, which may increase complexity for UE implementations and create inefficiencies during resource allocation. Additionally, HARQ processes may be restricted to retransmissions within the same component carrier, limiting flexibility and resource utilization across multiple component carriers. These challenges may result in increased latency, reduced throughput, and difficulties in maintaining communication continuity for the UE 104. These issues are particularly apparent in scenarios where serving cells span contiguous and non-contiguous frequency bands or when synchronization and scheduling operations are managed across multiple component carriers.

In some embodiments, the network 102 may generate configuration information 125 for the UE 104 to implement anchor BWP, cross-carrier scheduling, and semi-static BWP switching patterns. These solutions may enhance BWP switching operations, reduce ambiguity, and improve transmission efficiency in multi-carrier cells.

In some embodiments, the network 102 may generate configuration information 125 for the UE 104, wherein the configuration information 125 may include an anchor BWP 135. The anchor BWP 135 may remain unchanged during bandwidth part switching operations performed by the UE 104, ensuring signaling stability and reducing activation or deactivation delays. The anchor BWP 135 may include a downlink component configured for downlink transmissions and an uplink component configured for uplink transmissions. For example, the UE 104 may switch to BWP 145 for uplink or downlink transmissions while maintaining signaling stability through the anchor BWP 135. The network 102 may use the multi-carrier cell configuration 175 to schedule transmissions for the UE 104 across multiple component carriers.

In some embodiments, the network 102 may generate configuration information 125 for BWPs that include signaling channels and reference signals for uplink and downlink transmissions. For example, a downlink BWP may include control channels, such as a PDCCH, and reference signals, such as a TRS. Similarly, an uplink BWP may include control channels, such as a physical uplink control channel (PUCCH), and reference signals, such as a random access channel (RACH). These signaling channels and reference signals may support communication continuity, resource allocation, and synchronization between the UE 104 and the base station 108.

Quasi-co-location (QCL) relationships define the assumptions that the UE 104 may make about the spatial, timing, and/or frequency properties of channel conditions associated with different signals. In particular, a QCL relationship indicates that certain channel conditions associated with a source reference signal (for example, a TRS or SSB) can be assumed to apply to a target reference signal (e.g., TRS, SSB, a demodulation reference signal (DMRS), or a channel-state information-reference signal (CSI-RS). The different types of QCLs refer to different sets of channel conditions that are assumed to be related. QCL-Type A refers to Doppler shift, Doppler spread, and average delay spread, QCL-Type B refers to Doppler shift and Doppler spread, QCL-Type C refers to Doppler shift and average delay spread, and QCL-Type D refers to spatial receive parameters.

The transmission configuration indicator (TCI) is a mechanism that enables the network 102 to dynamically indicate to the UE 104 which specific spatial transmission configuration should be used for receiving downlink data or control channels. A TCI state specifies a set of antenna ports or beams and references one or more signals, such as SSB or CSI-RS, that the UE should use for channel estimation. TCI states are conveyed to the UE 104 through higher-layer signaling (such as RRC) or dynamically via downlink control information (DCI), allowing the UE to promptly adapt its reception strategy in response to changing beam or antenna configurations.

Each TCI state is defined by its QCL relationships with designated reference signals. When the network 102 signals a TCI state, it specifies to the UE 104 which reference signals'channel characteristics, according to the associated QCL type, are to be applied for demodulation and decoding of the scheduled downlink transmission. This mapping between downlink transmissions and their QCLed reference signals enables the UE 104 to utilize channel estimations derived from the indicated reference signals for reception and processing. For example, the UE 104 may reuse channel estimation from a referenced CSI-RS or SSB for demodulating a PDSCH or PDCCH, based on the QCL relationship encoded in the TCI state, thereby supporting demodulation or decoding operations even as the network 102 switches between different beams or antenna configurations.

In some instances, TCI may be a downlink mechanism. However, the network 102 may use QCL relationships in the uplink. The network 102 may use QCL associations to make assumptions about the channel characteristics of a UE's uplink transmission, based on its knowledge of downlink reference signals. For instance, if an uplink DMRS is configured to be QCLed with a downlink reference signal (such as a CSI-RS), the network may infer that certain spatial or temporal properties are shared between the uplink and downlink, facilitating reciprocity-based beamforming or simplifying uplink channel estimation at the gNB. This is particularly important in time division duplex (TDD) systems, where uplink and downlink transmissions share the same frequency resources, and channel reciprocity can be exploited.

In some embodiments, the network 102 may use SSBs of a PCell to support BWP switching operations for an SCell. QCL information may define the relationship between reference signals of the PCell and the SCell, enabling synchronization and resource allocation. For example, when a reference signal A from PCell is QCLed with a reference signal B from SCell, the UE 104 may assume that the channel conditions associated with reference signal B from the SCell also apply to reference signal A from the PCell. The QCL information may include a QCL-Type C association between a TRS in the SCell and an SSB in the PCell, and a QCL-Type A association between the TRS and the DMRS in the SCell. These QCL relationships may facilitate efficient bandwidth part switching and resource allocation between serving cells. In some embodiments, QCL source for TCI states may be defined per anchor BWP, or per serving cell. In some embodiments, the QCL source for tCI state may be defined per BWP.

In some embodiments, the network 102 may generate HARQ processes 165 for the UE 104 to support reliable data transmission in multi-carrier cells. HARQ processes 165 may allow retransmission of transport blocks associated with failed transmissions, ensuring data integrity and reducing transmission errors. For example, the network 102 may configure HARQ processes 165 to span multiple component carriers, enabling retransmissions across different component carriers in a multi-carrier cell configuration 175. These HARQ processes may optimize resource utilization and improve transmission efficiency for the UE 104.

In some embodiments, the network 102 may generate a BWP switching pattern 155 for the UE 104, wherein the BWP switching pattern 155 may include periodicity and switching occasions. The BWP switching pattern 155, which may be configured on a semi-static basis, may define predictable switching operations for the UE 104, reducing ambiguity and enhancing transmission efficiency. In some embodiments, the network 102 may utilize procedures to override the semi-static BWP switching pattern 155. These procedures may be based on downlink control information (DCI) provided at specific occasions, a BWP inactivity timer, or demand from the UE 104. These override mechanisms may support dynamic updates to the BWP switching pattern 155, ensuring flexibility and adaptability in bandwidth part switching operations.

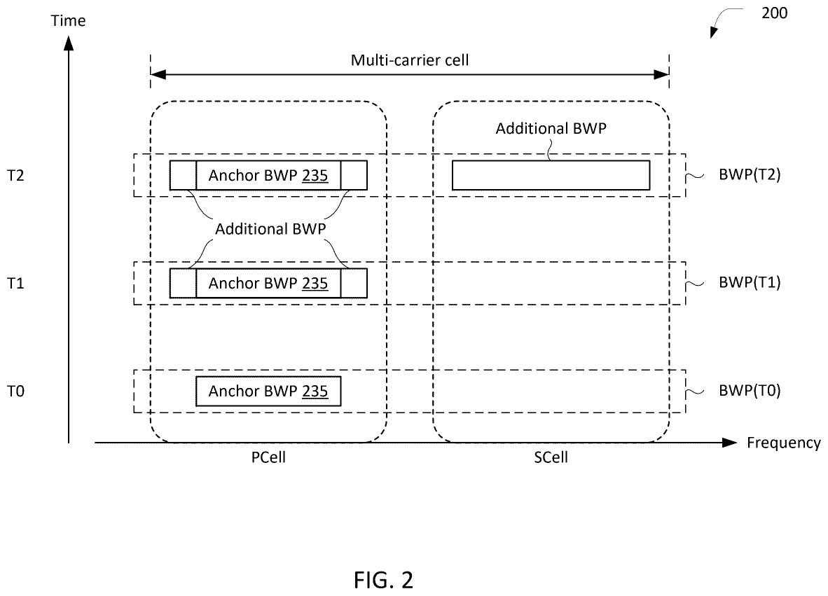

FIG. 2 illustrates a time-frequency diagram 200 in accordance with some embodiments. Time-frequency diagram 200 is an example of configuring anchor BWP 235 and switching BWPs at different times. The diagram depicts BWP management in a multi-carrier cell, including a PCell and an SCell. The multi-carrier cell may include multiple BWPs distributed across the PCell and the SCell, enabling uplink and downlink transmissions for the UE 104. The network 102 may configure the UE 104 with anchor BWP 235, which remains unchanged during bandwidth part switching operations, ensuring signaling stability and reducing activation or deactivation delays.

At T0, the network 102 may configure the UE 104 with BWP0, which is the anchor BWP 235. Anchor BWP 235 may be defined on the PCell and may include critical signaling elements, such as SSBs, TRS, and control channels (e.g., PDCCH for downlink operations and PUCCH for uplink operations). Anchor BWP 235 may remain unchanged during switching operations performed by the UE 104. BWP(T0) may be fully located within the PCell and may facilitate initial access and resource allocation for the UE 104. The anchor BWP 235 may include both uplink and downlink components and may serve as a stable reference for bandwidth part switching.

At T1, the UE 104 may switch bandwidth from BWP(T0) to BWP(T1). BWP(T1) may include anchor BWP 235 and one or more additional BWPs. The network 102 may configure additional BWPs within the PCell to provide expanded bandwidth for uplink and downlink transmissions. For example, BWP(T1) may include additional bandwidth resources to support increased data throughput or application requirements. Anchor BWP 235 may remain in the PCell during this switching operation, ensuring signaling stability and continuity for the UE 104. The UE 104 may perform bandwidth part switching to BWP(T1) while maintaining resource synchronization and communication continuity through anchor BWP 235.

At T2, the UE 104 may switch bandwidth to BWP(T2). BWP(T2) may span multiple serving cells, including portions in the PCell and portions in the SCell. The portion of BWP(T2) within the PCell may include anchor BWP 235 and additional BWPs, and the portion within the SCell may include further additional BWPs. Anchor BWP 235 may remain unchanged within the PCell, serving as a stable reference for synchronization and resource allocation during the bandwidth part switching operation. The additional BWPs in the SCell may provide expanded bandwidth resources for uplink or downlink transmissions, enabling the UE 104 to operate across non-contiguous frequency bands. The network 102 may define anchor BWP 235 to remain on the PCell, while additional BWPs may span the SCell to support multi-cell or multi-carrier operations.

In some embodiments, anchor BWP 235 may be defined on the PCell and may not be switched by the network 102. UL and DL components of anchor BWP 235 may be defined on the same component carrier or separate component carriers within the PCell. Additional BWPs may be dynamically configured within the PCell or across serving cells, such as SCell. For example, network 102 may configure additional BWPs to span both PCell and SCell, enabling the UE 104 to operate across contiguous or non-contiguous frequency bands. Anchor BWP 235 may ensure signaling stability during switching operations, while additional BWPs may provide expanded bandwidth for improved throughput and resource allocation.

In some embodiments, anchor BWP 235 may include signaling channels and reference signals to support uplink (UL) and downlink (DL) transmissions for the UE 104. For DL operations, anchor BWP 235 may include SSBs, TRS, and PDCCH, which provide synchronization, frequency tracking, and control information for resource allocation. Other component carriers may or may not include these DL signaling elements, depending on UE capability and whether the component carriers are collocated or span intra-band or inter-band frequency ranges. For UL operations, anchor BWP 235 may include PUCCH and RACH, which facilitate uplink control signaling and random access procedures. Other component carriers may or may not include these UL signaling elements. This configuration is unlike conventional NR systems, where each BWP may or may not include critical signaling like SSB and RACH. The network 102 may generate configuration information 125 to ensure that anchor BWP 235 includes the necessary signaling elements to maintain communication continuity and resource allocation during bandwidth part switching operations.

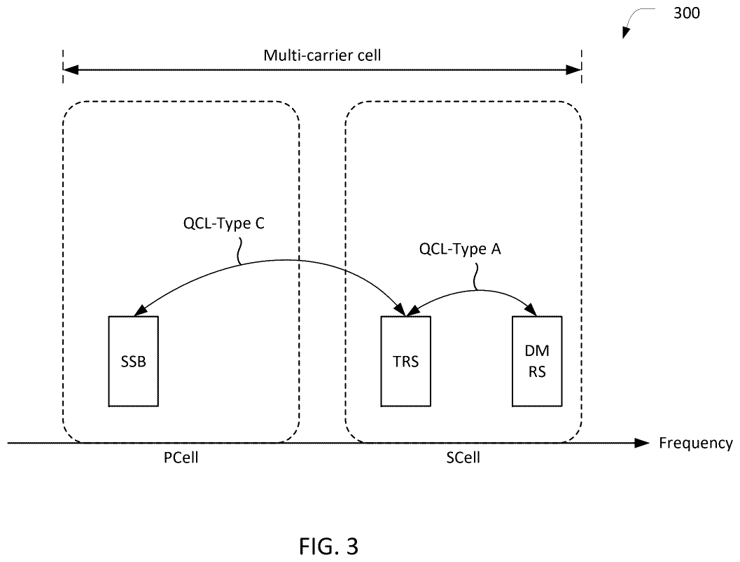

FIG. 3 illustrates an association 300 in accordance with some embodiments. The multi-carrier cell includes a PCell and an SCell, with reference signals transmitted across both serving cells. In this configuration, the PCell transmits SSBs, while the SCell transmits TRS and DMRS. The network 102 may configure the UE 104 to process these reference signals, ensuring synchronization, resource allocation, and efficient bandwidth utilization across the multi-carrier cell. In some embodiments, for BWPs spanning across the PCell and the SCell, the reference signals of the SCells may meet certain assumptions. In this example, the TRS transmitted in the SCell has a QCL-Type C relationship with the SSB transmitted in the PCell. This QCL-Type C relationship ensures that the frequency properties of the TRS in the SCell are the same as those of the SSB in the PCell, including Doppler shift and average delay spread. This enables the UE 104 to perform frequency tracking and synchronization across the PCell and SCell, facilitating efficient bandwidth part switching and multi-cell operations. Additionally, the TRS and DMRS transmitted in the SCell have a QCL-Type A relationship. This QCL-Type A relationship ensures that the Doppler shift, Doppler spread, and average delay spread of the channels of these reference signals are the same.

The QCL-Type C relationship between the SSB in the PCell and the TRS in the SCell may provide frequency alignment for multi-cell operations. By ensuring that the frequency properties of the TRS are shared with those of the SSB, the UE 104 may perform frequency tracking and synchronization across the PCell and SCell without requiring separate frequency offset measurements. This reduces complexity in UE implementations and ensures efficient communication continuity during bandwidth part switching operations.

The QCL-Type A relationship between the TRS and DMRS in the SCell complements the QCL-Type C relationship by defining a spatial relationship between the TRS and DMRS, allowing the UE to utilize the same beamforming characteristics for both signals.

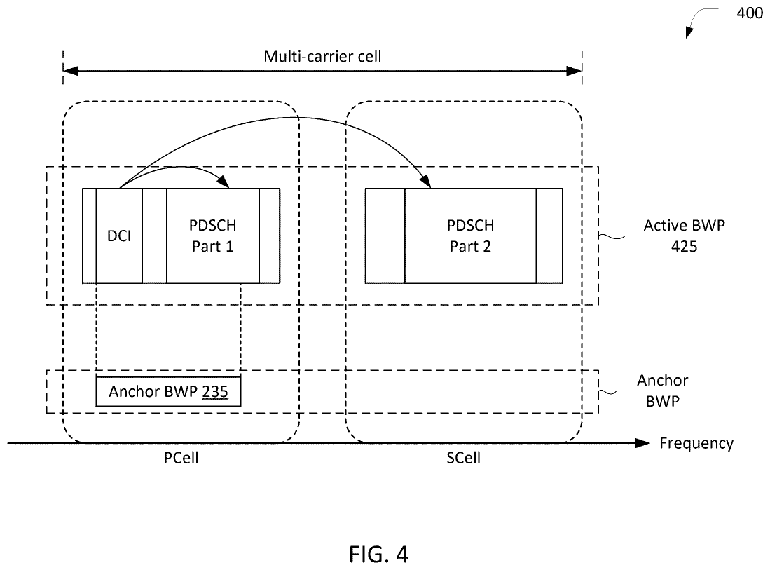

FIG. 4 illustrates a scheduling 400 of a multi-carrier cell in accordance with some embodiments. The multi-carrier cell includes a PCell and an SCell, with anchor BWP 235 and active BWP 425 spanning both serving cells. Anchor BWP 235 remains unchanged during bandwidth part switching operations, providing signaling stability and enabling resource synchronization for the UE 104. Active BWP 425 may represent the bandwidth part that is currently activated for uplink and downlink transmissions, spanning multiple component carriers across PCell and SCell and including the anchor BWP 235. Active BWP 425 may include additional bandwidth resources and may be dynamically configured or switched based on network conditions, application requirements, or traffic demand.

Activation or deactivation of a BWP may involve configuring the active BWP 425 for uplink or downlink transmissions, including control channels, reference signals, and data channels. During bandwidth part switching operations, the UE 104 may deactivate the current active BWP 425 and activate a new bandwidth part to adapt to changing resource requirements. Anchor BWP 235, however, is not switched during these operations, ensuring signaling continuity and synchronization for the UE 104. The network 102 may dynamically define active BWP 425 to span both PCell and SCell, enabling the UE 104 to utilize non-contiguous frequency resources across the multi-carrier cell configuration.

In some embodiments, the network 102 may generate and transmit DCI to the UE 104 within the active BWP 425. The UE 104 may receive and process the DCI to schedule PDSCH transmissions across PCell and SCell. For example, the DCI may schedule PDSCH transmissions on PRBs spanning both PCell and SCell, enabling efficient data transmission within the active BWP 425. A single PDSCH (or PUSCH) may be scheduled across multiple component carriers, unlike conventional 5G systems where PDSCH (and PUSCH) scheduling is limited to a single component carrier. Active BWP 425 facilitates multi-cell operations by allowing scheduling of PRBs across non-contiguous frequency bands.

The network 102 may configure HARQ processes for the active BWP 425 to support reliable data transmission across PCell and SCell. These HARQ processes may facilitate retransmission of transport blocks that were originally scheduled on PRBs spanning both PCell and SCell. All component carriers within the multi-carrier cell may share the same HARQ processes, enabling retransmissions across multiple component carriers. This configuration breaks the one-to-one mapping between HARQ processes and individual cells, and allows for an increase in the number of HARQ processes available for the supercell. Additionally, retransmission of transport blocks originally sent on one set of component carriers may occur across different component carriers, reducing retransmission delays and improving resource utilization. By linking HARQ processes to DCI scheduling within the active BWP 425, the network 102 ensures reliable and efficient data transmission for the UE 104.

Anchor BWP 235 provides a stable signaling reference for bandwidth part switching operations, while active BWP 425 enables dynamic resource allocation across PCell and SCell. The network 102 may configure PDCCH within anchor BWP 235 to schedule uplink and downlink transmissions across all component carriers in the multi-carrier cell. This configuration ensures that anchor BWP 235 remains unchanged during switching operations, enabling synchronization and resource continuity for the UE 104. Active BWP 425 may adapt dynamically to changing network conditions, supporting efficient data transmission and resource management across the multi-carrier cell.

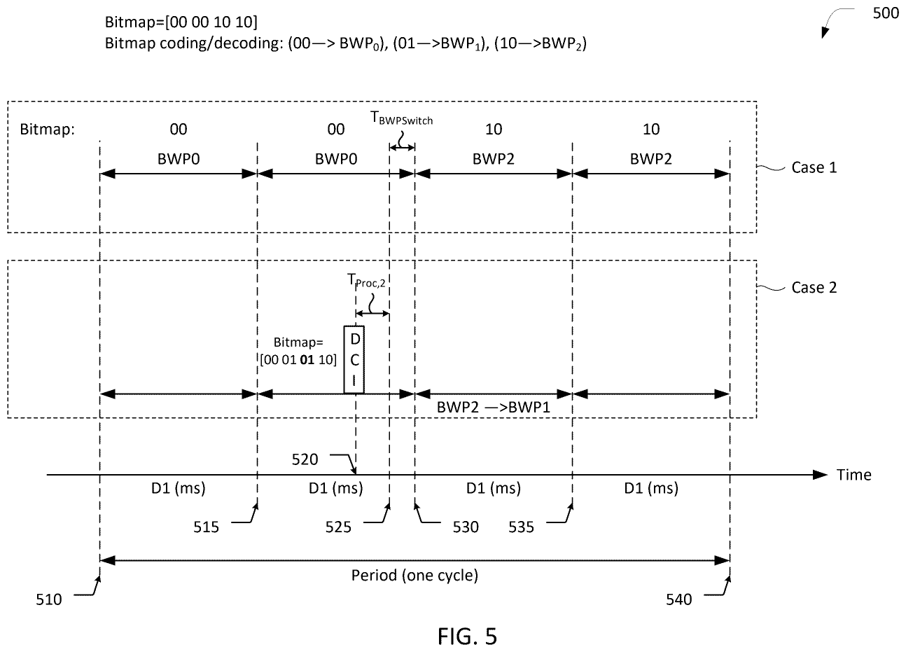

FIG. 5 illustrates a bandwidth part (BWP) switching pattern 500 in accordance with some embodiments. The BWP switching pattern 500 shows how the network 102 configures the UE 104 to perform semi-static BWP switching based on periodicity, switching occasions, and override mechanisms. The figure includes two cases: Case 1, which demonstrates a semi-static BWP switching pattern repeating over time, and Case 2, which introduces an override mechanism triggered by downlink control information (DCI) received from the network 102. FIG. 5 also depicts the time interval associated with switching operations (TBWPSwitch) and the timing constraints for receiving DCI (Tproc,2).

In some embodiments, the network 102 may configure the UE 104 with a semi-static BWP switching pattern 500. The semi-static BWP switching pattern may define periodicity and switching occasions, which are configured using radio resource control (RRC) signaling. As described in Case 1, the periodicity of the pattern may occur in integer multiples of slots, enabling predictable and efficient bandwidth part switching for the UE 104. A bitmap may semi-statically indicate the BWP switching occasions, where each bit or group of bits in the bitmap corresponds to a specific BWP. For example, the bitmap [00 00 10 10] defines the sequence of BWPs to be switched over one cycle, ensuring communication continuity and reducing ambiguity during switching operations.

Case 1 illustrates a semi-static BWP switching pattern 500 with a periodicity spanning four intervals (D1 ms) between times 510 and 540. The RRC-configured bitmap [00 00 10 10] defines the BWP switching occasions for each interval. At time 510, the UE 104 starts with BWP0, which is associated with the bits [00] in the bitmap. BWP0 remains active for the first interval (D1 ms). At time 520, the bitmap indicates that the UE 104 continues to use BWP0 for the second interval (D1 ms). At time 530, the UE 104 switches to BWP2, which is associated with the bits [10] in the bitmap. BWP2 remains active for the third interval (D1 ms). At time 535, the bitmap indicates that the UE 104 continues to use BWP2 for the fourth interval (D1 ms). At time 540, the cycle completes, and the UE 104 repeats the semi-static BWP switching pattern.

Case 2 demonstrates how the semi-static BWP switching pattern 500 may be overridden by the network 102 using DCI. The initial bitmap for Case 2 is the same as Case 1, [00 00 10 10]. However, at time 520, the network 102 transmits DCI to the UE 104, indicating an override of the bitmap. The new bitmap [00 01 01 10] specifies updated BWP switching occasions for subsequent intervals. At time 525, during the T_BWPSwitch interval, the UE 104 switches to BWP1, which is associated with the bits [01] in the new bitmap. The UE 104 continues to use BWP1 for the next interval, as indicated by the new bitmap. At time 540, the cycle completes, and the UE 104 applies the updated BWP switching pattern for subsequent cycles.

In some embodiments, the UE 104 may perform BWP switching during the T_BWPSwitch interval. T_BWPSwitch is the time allocated for the UE 104 to perform switching operations between bandwidth parts. This interval may occur before the start of the next BWP switching occasion and is subject to UE capability. For example, in FIG. 5, the T_BWPSwitch interval begins at time 525 and allows the UE 104 to switch from BWP0 to BWP2 (Case 1) or from BWP0 to BWP1 (Case 2). The timing of the T_BWPSwitch interval ensures that switching operations are completed before the next BWP becomes active.

It may be desired that the timing of the DCI transmission ensures it occur at least Tproc,2 before the start of the T_BWPSwitch interval. For example, in FIG. 5, the DCI is transmitted at time 520, which satisfies the timing constraint relative to the T_BWPSwitch interval starting at time 525. Upon receiving the DCI, the UE 104 may process the control information and update the BWP switching pattern accordingly. The new pattern may include changes to periodicity, switching occasions, or the sequence of BWPs, ensuring flexibility and adaptability in bandwidth part management.

The UE 104 may not be expected to transmit or receive within T_BWPSwitch before the start of the semi-statically indicated BWP switch time. The value T_BWPSwitch may be subject to UE capability. In some embodiments, the UE 104 may signal this capability to the network. In some embodiments, the T_BWPSwitch may be at an end of duration associated with an old BWP, as shown in FIG. 5. In other embodiments, the T_BWPSwitch may be at a start of a duration corresponding to the new BWP.

Anchor BWP 235 remains unchanged during the BWP switching operations depicted in FIG. 5. Regardless of the semi-static pattern or DCI override, anchor BWP 235 provides a stable signaling reference for synchronization and resource allocation. The active BWPs (e.g., BWP0, BWP1, and BWP2) may span both PCell and SCell, enabling efficient multi-cell operations and resource utilization. By defining predictable switching patterns and supporting dynamic overrides, the network 102 ensures reliable communication continuity and optimized bandwidth utilization for the UE 104.

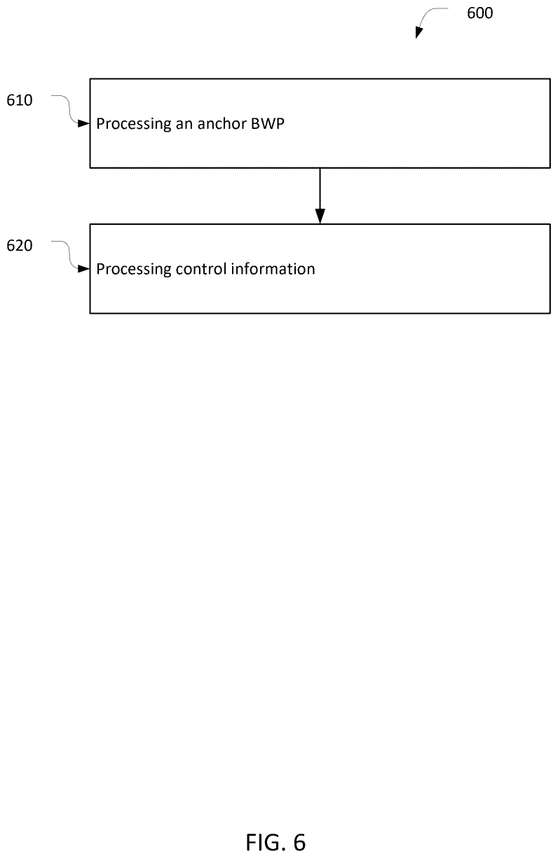

FIG. 6 illustrates an operation flow/algorithmic structure 600, also referred to as process 600, in accordance with some embodiments. The operation flow/algorithmic structure 600 may be performed or implemented by a UE such as, for example, the UE 104 or UE 900; or components thereof, for example, baseband processor circuitry 904A.

The operation flow/algorithmic structure 600 may include, at 610, processing a configuration of anchor BWP 235. The configuration may include signaling elements such as SSB, TRS, and control channels (e.g., PDCCH for downlink operations and PUCCH for uplink operations). The configuration may be associated with activation or deactivation of a serving cell and may ensure signaling stability during bandwidth part switching operations. Anchor BWP 235 may remain unchanged during switching operations performed by process 600, enabling communication continuity and resource synchronization.

In some embodiments, the operation flow/algorithmic structure 600 may include processing control information configured in anchor BWP 235. The control information may include at least one configuration parameter for bandwidth part switching operations. The configuration parameter may define signaling properties, activation conditions, or communication protocols for bandwidth part switching, ensuring efficient and predictable switching operations.

In some embodiments, the operation flow/algorithmic structure 600 may include processing at least one additional BWP that spans one or more component carriers. The additional BWP may be dynamically configured within the PCell or across SCell, providing expanded bandwidth resources for uplink and downlink transmissions. The additional BWP may be associated with applications requiring higher data throughput or resource allocation across contiguous or non-contiguous frequency bands.

The operation flow/algorithmic structure 600 may include, at 620, processing control information. The control information may facilitate activation or deactivation of serving cells based on anchor BWP 235. For example, process 600 may process signaling elements such as SSB, TRS, PDCCH, PUCCH, or RACH configured in anchor BWP 235 to support resource allocation and synchronization between serving cells.

In some embodiments, the operation flow/algorithmic structure 600 may include processing a first BWP that spans both PCell and SCell. Anchor BWP 235 may be located in a portion of the first BWP spanning the PCell, and additional BWPs may span both the PCell and SCell. Process 600 may further process QCL information defining the relationship between the PCell and SCell. For example, the QCL information may indicate a QCL-Type C association between the TRS in the SCell and the SSB of anchor BWP 235, ensuring frequency alignment and synchronization between serving cells. The QCL information may also indicate a QCL-Type A association between the TRS and DMRS in the SCell, enabling spatial alignment for improved beamforming and signal quality.

In some embodiments, process 600 may include processing scheduling information included in anchor BWP 235. The scheduling information may enable PDSCH or PUSCH to span PRBs across multiple component carriers. Process 600 may further process retransmission of transport blocks associated with PDSCH or PUSCH transmissions. The retransmissions may occur across different component carriers, ensuring reliable data transmission and reducing retransmission delays.

In some embodiments, process 600 may include configuring anchor BWP 235 to enable retransmissions of transport blocks across a plurality of component carriers in inter-band configurations. The configuration may support communication continuity and resource optimization for multi-carrier operations.

In some embodiments, process 600 may include processing QCL information that enables activation of a secondary serving cell. The QCL information may define spatial, timing, and frequency relationships between reference signals in anchor BWP 235 and additional BWPs spanning the SCell. By processing this information, process 600 may ensure synchronization and resource allocation across serving cells.

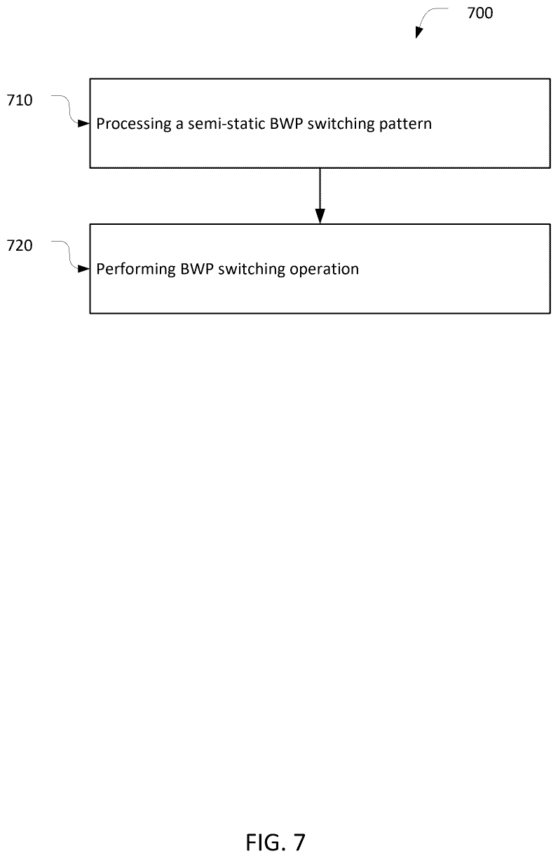

FIG. 7 illustrates an operation flow/algorithmic structure 700, also referred to as process 700, in accordance with some embodiments. The operation flow/algorithmic structure 700 may be performed or implemented by a UE such as, for example, the UE 104 or UE 900; or components thereof, for example, baseband processor circuitry 904A.

The operation flow/algorithmic structure 700 may include, at 710, processing a semi-static BWP switching pattern. The semi-static BWP switching pattern may define bandwidth part switching occasions and periodicity, allowing predictable switching operations for process 700. The periodicity may be configured using RRC signaling and may occur in integer multiples of slots. The semi-static BWP switching pattern may ensure communication continuity and resource allocation during bandwidth part switching operations.

In some embodiments, process 700 may include processing a bitmap associated with the semi-static BWP switching pattern. The bitmap may semi-statically indicate bandwidth part switching occasions, where each bit or group of bits corresponds to a specific BWP. For example, process 700 may use the bitmap to determine the sequence and timing of bandwidth part switching during a cycle, reducing ambiguity and ensuring efficient switching operations.

In some embodiments, process 700 may include processing an override of the semi-static BWP switching pattern. The override may be triggered based on DCI received at a specific occasion. Process 700 may receive and process the DCI to update the semi-static BWP switching pattern. The updated pattern may include changes to periodicity, switching occasions, or the sequence of BWPs, ensuring flexibility and adaptability in bandwidth part management.

In some embodiments, process 700 may include processing an override of the semi-static BWP switching pattern based on a demand from the UE. The demand may specify updated switching requirements or resource configurations, allowing process 700 to adapt the bandwidth part switching pattern dynamically.

In some embodiments, process 700 may include processing an override of the semi-static BWP switching pattern based on a BWP inactivity timer. The inactivity timer may expire when no active transmissions are detected within a predefined period, prompting process 700 to update the semi-static BWP switching pattern.

The operation flow/algorithmic structure 700 may include, at 720, performing BWP switching operation. Process 700 may perform switching at a bandwidth part switching occasion indicated by the semi-static BWP switching pattern. The switching operation may involve transitioning between BWPs based on the bitmap, periodicity, or override mechanisms, ensuring efficient resource allocation and communication continuity.

In some embodiments, process 700 may include processing a switching delay associated with the semi-static BWP switching pattern. The switching delay may occur before the start of the next bandwidth part switching occasion and may be subject to UE capability. For example, process 700 may allocate time for switching operations to ensure synchronization and continuity during bandwidth part transitions.

In some embodiments, process 700 may include processing a switching delay at the end of a duration associated with the current BWP. The switching delay may allow process 700 to deactivate the current BWP and prepare for activation of the next BWP in the sequence.

In some embodiments, process 700 may include processing a switching delay at the start of a duration associated with the next BWP. The delay may ensure that the next BWP is activated at the appropriate time, allowing process 700 to maintain synchronization and resource allocation during switching operations.

In some embodiments, process 700 may include processing DCI to override the semi-static BWP switching pattern. The timing of the DCI transmission may satisfy predefined constraints, such as being received at least a processing time before the switching interval. Process 700 may process the DCI to update the switching pattern, ensuring efficient communication and resource management.

In some embodiments, process 700 may include processing DCI to replace the semi-static BWP switching pattern with a new pattern. The new pattern may define updated bandwidth part switching occasions, periodicity, or the sequence of BWPs, ensuring adaptability to changing network conditions.

In some embodiments, process 700 may include processing DCI indicating periodicity and bandwidth part switching occasions different from those defined in the original semi-static BWP switching pattern. Process 700 may adapt the switching operations to align with the updated periodicity and switching occasions, ensuring efficient bandwidth utilization.

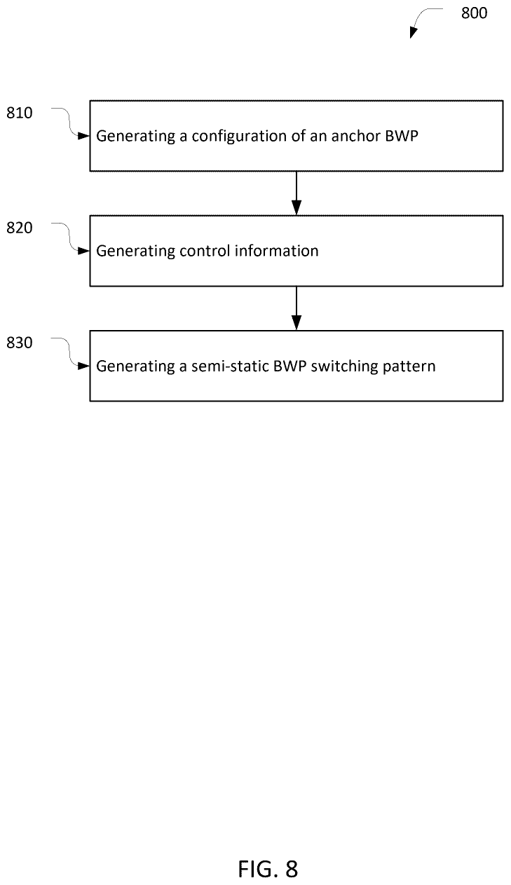

FIG. 8 illustrates an operational flow/algorithmic structure 800, also referred to as process 800, in accordance with some embodiments. The operation flow/algorithmic structure 800 may be performed or implemented by a base station such as, for example, the base station 108 or the base station 1000; or components thereof, for example, baseband processor circuitry 1004A.

The operation flow/algorithmic structure 800 may include, at 810, generating a configuration of an anchor BWP 135 or 235. The control information may include at least one configuration parameter for bandwidth part switching operations, defining conditions for activation, synchronization, or resource allocation. Process 800 may further configure additional BWPs for the UE, where the additional BWPs may span one or more component carriers. The additional BWPs may provide expanded bandwidth for uplink and downlink transmissions, supporting applications requiring higher data throughput or multi-carrier operations.

In some embodiments, process 800 may include generating signaling for uplink and downlink operations in anchor BWP 135. For downlink operations, process 800 may generate signaling elements such as SSB, PDCCH, and TRS configured in anchor BWP 135. For uplink operations, process 800 may generate signaling elements such as PUCCH and RACH configured in anchor BWP 135. These signaling elements ensure synchronization, frequency tracking, and control information for efficient communication between the base station and the UE.

The operation flow/algorithmic structure 800 may include, at 820, generating control information. Process 800 may generate control information associated with serving cell activation and deactivation based on anchor BWP 135. The control information may define relationships between the PCell and SCell, enabling synchronization and resource allocation. For example, process 800 may generate QCL information indicating a QCL-Type C association between the TRS in the SCell and the SSB of anchor BWP 135, ensuring frequency alignment and synchronization. Process 800 may also generate QCL information indicating a QCL-Type A association between the TRS and DMRS in the SCell, enabling spatial alignment for improved beamforming and signal quality.

In some embodiments, process 800 may include generating scheduling information included in anchor BWP 135. The scheduling information may enable PDSCH or PUSCH transmissions to span PRBs across multiple component carriers. Process 800 may further generate control information to configure HARQ processes shared across the multiple component carriers. HARQ processes may facilitate retransmission of transport blocks originally transmitted on one set of component carriers to occur across different component carriers, ensuring reliable data transmission and reducing retransmission delays.

The operation flow/algorithmic structure 800 may include, at 830, generating a semi-static BWP switching pattern. Process 800 may define the semi-static BWP switching pattern with periodicity and switching occasions, enabling predictable bandwidth part switching operations for the UE. Process 800 may generate a bitmap associated with the semi-static BWP switching pattern, where the bitmap semi-statically indicates switching occasions. Each bit or group of bits in the bitmap may correspond to a specific BWP, ensuring efficient resource allocation and communication continuity.

In some embodiments, process 800 may include generating control information to override the semi-static BWP switching pattern. The override may be triggered based on one of DCI transmitted at a specific occasion, a bandwidth part inactivity timer, or a demand from the UE. Process 800 may ensure that the control information satisfies predefined timing constraints, such as being transmitted at least a processing time prior to the switching interval. The override may enable process 800 to dynamically adapt the bandwidth part switching pattern to changing network conditions.

In some embodiments, process 800 may include generating DCI to replace the semi-static BWP switching pattern with a new pattern. The new pattern may define updated periodicity, switching occasions, or the sequence of BWPs, ensuring flexibility and adaptability in bandwidth part management. Process 800 may also generate DCI indicating periodicity and switching occasions different from those defined in the original semi-static BWP switching pattern, ensuring efficient bandwidth utilization and communication continuity.

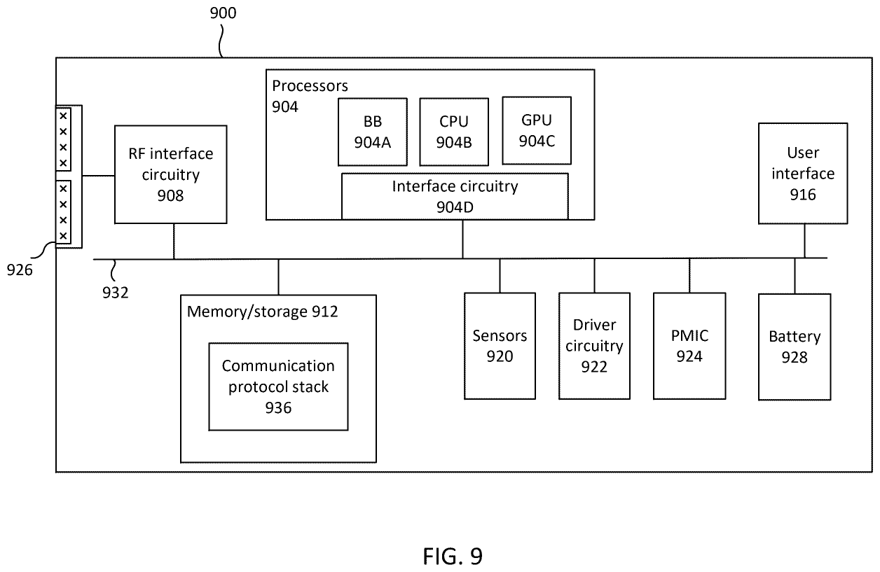

FIG. 9 illustrates a UE 900 in accordance with some embodiments. The UE 900 may be similar to and substantially interchangeable with the UE 104.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein. The processors 904 may also include interface circuitry 904D to communicatively couple the processor circuitry with one or more other components of the UE 900.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein.

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor circuitry 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within or connected to the UE 900. For example, driver circuitry 922 may include a display driver to control and allow access to a display device, a touchscreen driver to control and allow access to a touchscreen interface, sensor drivers to obtain sensor readings of sensors 920, and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples, the UE 900 may be mounted deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

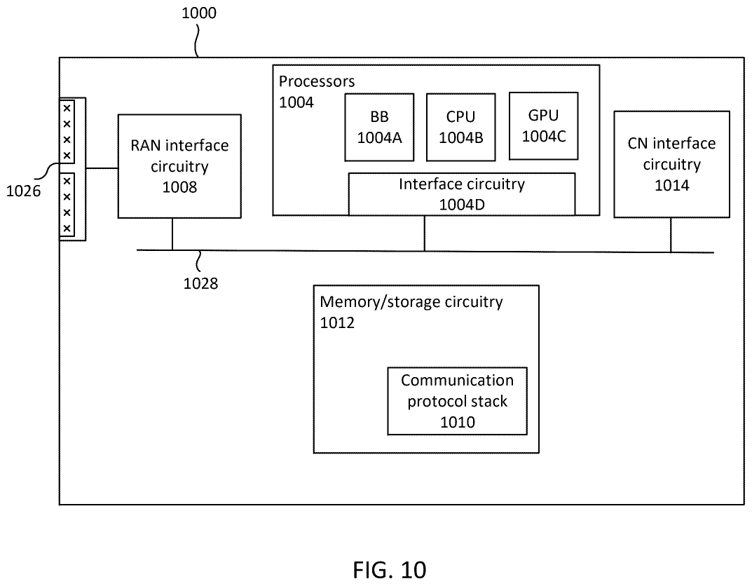

FIG. 10 illustrates a network device 1000 in accordance with some embodiments. The network device 1000 may be similar to and substantially interchangeable with base station 108.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the UE 900 to perform operations as described herein. The processors 1004 may also include interface circuitry 1004D to communicatively couple the processor circuitry with one or more other components of the network device 1000.

The CN interface circuitry 1014 may provide connectivity to a core network, for example, a 5th Generation Core network (5GC) using a 5GC-compatible network interface protocol such as carrier Ethernet protocols or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices generally recognized as meeting or exceeding industry or governmental requirements for maintaining users'privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: processing an anchor bandwidth part (BWP), wherein the anchor BWP is excluded from BWP switching operations performed by a user equipment (UE); and processing control information associated with activation or deactivation of a serving cell based on the anchor BWP.

Example 2 includes the method of example 1 or some other example herein, further including: processing control information configured that includes at least one configuration parameter for the BWP switching operations.

Example 3 includes the method of example 1 or some other example herein, further including: processing at least one additional BWP that spans one or more component carriers.

Example 4 includes the method of example 1 or some other example herein, further including: maintaining signaling associated with a synchronization signal block (SSB) configured in the anchor BWP during the BWP switching operations.

Example 5 includes the method of example 1 or some other example herein, wherein the anchor BWP is a downlink BWP, and the method further includes: processing a physical downlink control channel configured in the downlink BWP.

Example 6 includes the method of example 1 or some other example herein, wherein the anchor BWP is an uplink BWP, and further including: processing a physical uplink control channel configured in the uplink BWP.

Example 7 includes the method of example 1 or some other example herein, wherein the anchor BWP is an uplink BWP, and further including: processing a random access channel configured in the uplink BWP.

Example 8 includes the method of example 1 or some other example herein, further including: processing a first bandwidth part (BWP) that is non-contiguous and spans a primary serving cell (PCell) and a secondary serving cell (SCell), wherein the anchor BWP is in a portion of the first BWP that spans the PCell; and processing quasi-co-location (QCL) information associated with PCell and the SCell, wherein the QCL information indicates a QCL-type C association between a tracking reference signal (TRS) in a portion of the first BWP that spans the SCell and a synchronization signal block (SSB) of the anchor BWP.

Example 9 includes the method of example 8 or some other example herein, wherein the QCL information indicates a QCL-type A association between the TRS and a demodulation reference signal (DMRS) in a portion of the first BWP that spans the SCell.

Example 10 includes the method of example 1 or some other example herein, wherein the anchor BWP is associated with a primary cell and includes quasi-co-location information enabling activation of a secondary cell.

Example 11 includes the method of example 1 or some other example herein, further including: processing a physical downlink control channel configured in the anchor BWP to schedule uplink or downlink transmissions across a plurality of component carriers.

Example 12 includes the method of example 11 or some other example herein, further including: sharing hybrid automatic repeat request (HARQ) processes across the plurality of component carriers.

Example 13 includes the method of example 1 or some other example herein, further including: processing scheduling information included in the anchor BWP, wherein the scheduling information enables a physical downlink shared channel (PDSCH) or a physical uplink shared channel (PUSCH) to span physical resource blocks across a first set of component carriers; and processing retransmission of a transport block associated with the physical downlink shared channel or physical uplink shared channel across a second set of component carriers.

Example 14 includes the method of example 1 or some other example herein, further including: scheduling uplink or downlink transmissions across a plurality of component carriers using scheduling information included in the anchor BWP.

Example 15 includes the method of example 1 or some other example herein, further including: configuring the anchor BWP to enable retransmissions of transport blocks across a plurality of component carriers in inter-band configurations.

Example 16 includes the method of example 16 or some other example herein, including: processing a semi-static bandwidth part (BWP) switching pattern configured for a user equipment (UE), wherein the semi-static BWP switching pattern includes bandwidth part switching occasions and periodicity; and performing BWP switching operation at a BWP switching occasion of the BWP switching occasions included in the semi-static BWP switching pattern.

Example 17 includes the method of example 16 or some other example herein, wherein the semi-static BWP switching pattern includes a bitmap indicative of BWP switching occasions, and the bitmap is configured to semi-statically indicate the BWP switching occasions.

Example 18 includes the method of example 16 or some other example herein, further including: processing an override of the semi-static BWP switching pattern, wherein the override is triggered based on downlink control information (DCI) received at a specific occasion.

Example 19 includes the method of example 16 or some other example herein, further including: processing an override of the semi-static BWP switching pattern, wherein the override is triggered based on a demand from the UE.

Example 20 includes the method of example 16 or some other example herein, further including: processing an override of the semi-static BWP switching pattern, wherein the override is triggered based on a BWP inactivity timer.

Example 21 includes the method of example 16 or some other example herein, further including: processing a switching delay associated with the semi-static BWP switching pattern, wherein the switching delay occurs before a start of the BWP switching time indicated by the semi-static BWP switching pattern.

Example 22 includes the method of example 16 or some other example herein, further including: processing a switching delay associated with the semi-static BWP switching pattern, wherein the switching delay is at an end of a duration associated with an old BWP included in the semi-static BWP switching pattern.

Example 23 includes the method of example 16 or some other example herein, further including: processing a switching delay associated with the semi-static BWP switching pattern, wherein the switching delay is at a start of a duration associated with a new BWP included in the semi-static BWP switching pattern.

Example 24 includes the method of example 16 or some other example herein, further including: processing an override of the semi-static BWP switching pattern, wherein the override is triggered by downlink control information (DCI) received not later than a processing time before the BWP switching time associated with the semi-static BWP switching pattern.

Example 25 includes the method of example 16 or some other example herein, further including: processing downlink control information (DCI) associated with the semi-static BWP switching pattern, wherein the DCI indicates a new BWP switching pattern replacing the semi-static BWP switching pattern.

Example 26 includes the method of example 16 or some other example herein, further including: processing downlink control information (DCI) associated with the semi-static BWP switching pattern, wherein the DCI indicates a periodicity and BWP switching occasions different from the periodicity and BWP switching occasions included in the semi-static BWP switching pattern.

Example 27 includes the method of example 27 or some other example herein, including: generating an anchor bandwidth part (BWP) for transmission to a user equipment (UE), wherein the anchor BWP is excluded from BWP switching operations performed by the UE; generating control information for transmission to the UE, wherein the control information is associated with activation or deactivation of a serving cell based on the anchor BWP; and generating a semi-static BWP switching pattern for transmission to the UE, wherein the semi-static BWP switching pattern includes BWP switching occasions and periodicity.

Example 28 includes the method of example 27 or some other example herein, further including: generating control information configured in the anchor BWP, wherein the control information includes at least one configuration parameter for BWP switching operations; and configuring at least one additional BWP for the UE, wherein the additional BWP spans one or more component carriers.

Example 29 includes the method of example 27 or some other example herein, wherein the anchor BWP is a downlink BWP, and the method further includes: generating signaling associated with a synchronization signal block (SSB), a physical downlink control channel (PDCCH), and a tracking reference signal (TRS) configured in the downlink BWP; and generating signaling associated with a physical uplink control channel (PUCCH) and a random access channel (RACH) configured in an uplink BWP.

Example 30 includes the method of example 27 or some other example herein, further including: generating quasi-co-location (QCL) information associated with a serving cell, wherein the QCL information indicates an association between a tracking reference signal (TRS) and a synchronization signal block (SSB) of the anchor BWP; and generating QCL information enabling activation of a secondary cell associated with the anchor BWP.

Example 31 includes the method of example 27 or some other example herein, further including: generating scheduling information included in the anchor BWP, wherein the scheduling information enables a physical downlink shared channel (PDSCH) or a physical uplink shared channel (PUSCH) to span physical resource blocks across multiple component carriers; generating first control information to configure hybrid automatic repeat request (HARQ) processes shared across the multiple component carriers; and generating second control information enabling retransmission of a transport block associated with a serving cell across component carriers different from the component carriers on which the transport block was originally transmitted.

Example 32 includes the method of example 27 or some other example herein, further including: generating a bitmap associated with the semi-static BWP switching pattern, wherein the bitmap semi-statically indicates BWP switching occasions; generating first control information to override the semi-static BWP switching pattern, wherein the override is triggered based on at least one of: downlink control information (DCI) transmitted at a specific occasion, a bandwidth part inactivity timer, or a demand from the UE; generating second control information to manage a switching delay associated with the semi-static BWP switching pattern, wherein the switching delay occurs before a start of the BWP switching time indicated by the semi-static BWP switching pattern; and generating downlink control information (DCI) associated with the semi-static BWP switching pattern, wherein the DCI indicates a periodicity and BWP switching occasions different from the periodicity and BWP switching occasions included in the semi-static BWP switching pattern.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a configuration of an anchor bandwidth part (BWP), wherein the anchor BWP is excluded from BWP switching operations performed by a user equipment (UE); and
processing control information associated with activation or deactivation of a serving cell based on the anchor BWP.

2. The method of claim 1, further comprising:
processing control information that includes at least one configuration parameter for the BWP switching operations.

3. The method of claim 1, further comprising:
maintaining signaling associated with a synchronization signal block (SSB) configured in the anchor BWP during the BWP switching operations.

4. The method of claim 1, wherein the anchor BWP is a downlink BWP and the method further comprises processing a physical downlink control channel in the downlink BWP to schedule a transmission in another BWP.

5. The method of claim 1, further comprising:
processing a configuration of a first bandwidth part (BWP) that is non-contiguous and spans a primary serving cell (PCell) and a secondary serving cell (SCell), wherein the anchor BWP is in a portion of the first BWP that spans the PCell; and
processing quasi-co-location (QCL) information associated with PCell and the SCell, wherein the QCL information indicates a QCL-type C association between a tracking reference signal (TRS) in a portion of the first BWP that spans the SCell and a synchronization signal block (SSB) of the anchor BWP.

6. The method of claim 1, further comprising
processing quasi-co-location (QCL) information, wherein the QCL information is associated with the anchor BWP, and wherein the QCL information indicates a QCL-type A association between the TRS and a demodulation reference signal (DMRS) in a portion of the first BWP that spans the SCell.

7. The method of claim 1, wherein the anchor BWP is associated with a primary cell and the configuration of the anchor BWP includes quasi-co-location information enabling activation of a secondary cell.

8. The method of claim 1, further comprising:
generating, for transmission in the anchor BWP, hybrid automatic repeat request (HARQ) information associated with another BWP.

9. The method of claim 1, further comprising:
processing scheduling information included in the anchor BWP, wherein the scheduling information enables a physical downlink shared channel (PDSCH) or a physical uplink shared channel (PUSCH) to span physical resource blocks across a first set of component carriers; and
processing retransmission of a transport block associated with the physical downlink shared channel or physical uplink shared channel across a second set of component carriers.

10. The method of claim 1, wherein the configuration of the anchor BWP is to configure retransmissions of a transport block across a plurality of component carriers.

11. An apparatus comprising:
processor circuitry to:
process configuration information that indicates a semi-static bandwidth part (BWP) switching pattern for a user equipment (UE), wherein the semi-static BWP switching pattern includes BWP switching occasions and a periodicity; and
perform a BWP switching operation at a first BWP switching occasion of the BWP switching occasions included in the semi-static BWP switching pattern; and
interface circuitry coupled to the processor circuitry to receive the configuration information.

12. The apparatus of claim 11, wherein the configuration information includes a bitmap indicative of the BWP switching occasions, and the bitmap is configured to semi-statically indicate the BWP switching occasions.

13. The apparatus of claim 11, wherein the processor circuitry is further to process an override of the semi-static BWP switching pattern, wherein the override is triggered based on: a downlink control information (DCI) received at a specific occasion, a demand from the UE, or a BWP inactivity timer.

14. The apparatus of claim 11, wherein the processor circuitry is further to process a switching delay associated with the semi-static BWP switching pattern, wherein the switching delay: occurs before a start of the BWP switching time indicated by the semi-static BWP switching pattern, is at an end of a duration associated with an old BWP included in the semi-static BWP switching pattern, or is at a start of a duration associated with a new BWP included in the semi-static BWP switching pattern.

15. The apparatus of claim 11, wherein the processor circuitry is further to process downlink control information (DCI) associated with the semi-static BWP switching pattern, wherein the DCI indicates a periodicity and BWP switching occasions different from the periodicity and BWP switching occasions included in the semi-static BWP switching pattern.

16. A method comprising:
configuring an anchor bandwidth part (BWP) for a user equipment (UE), wherein the anchor BWP is excluded from BWP switching operations performed by the UE;
generating control information for transmission to the UE, wherein the control information is associated with activation or deactivation of a serving cell based on the anchor BWP; and
configuring a semi-static BWP switching pattern for the UE, wherein the semi-static BWP switching pattern includes BWP switching occasions and a periodicity.

17. The method of claim 16, further comprising:
generating control information for transmission in the anchor BWP, wherein the control information includes at least one configuration parameter for BWP switching operations; or
configuring at least one additional BWP for the UE, wherein the additional BWP spans one or more component carriers.

18. The method of claim 16, further comprising:
generating, for transmission to the UE, quasi-co-location (QCL) information associated with a serving cell, wherein the QCL information indicates an association between a tracking reference signal (TRS) and a synchronization signal block (SSB) of the anchor BWP; or
generating, for transmission to the UE, QCL information enabling activation of a secondary cell associated with the anchor BWP.

19. The method of claim 16, further comprising:
generating, for transmission to the UE, scheduling information to enable a physical downlink shared channel (PDSCH) or a physical uplink shared channel (PUSCH) to span physical resource blocks across multiple component carriers;
generating, for transmission to the UE, first control information to configure hybrid automatic repeat request (HARQ) processes shared across the multiple component carriers; or
generating, for transmission to the UE, second control information enabling retransmission of a transport block associated with a serving cell across component carriers different from the component carriers on which the transport block was originally transmitted.

20. The method of claim 16, further comprising:
generating, for transmission to the UE, a bitmap associated with the semi-static BWP switching pattern, wherein the bitmap semi-statically indicates BWP switching occasions;
generating, for transmission to the UE, first control information to override the semi-static BWP switching pattern, wherein the override is triggered based on at least one of:
downlink control information (DCI) transmitted at a specific occasion,
a bandwidth part inactivity timer, or
a demand from the UE;
generating, for transmission to the UE, second control information to manage a switching delay associated with the semi-static BWP switching pattern, wherein the switching delay occurs before a start of the BWP switching time indicated by the semi-static BWP switching pattern; or
generating, for transmission to the UE, downlink control information (DCI) associated with the semi-static BWP switching pattern, wherein the DCI indicates a periodicity and BWP switching occasions different from the periodicity and BWP switching occasions included in the semi-static BWP switching pattern.
